(19) United States
(12) Patent Application Publication
(10) Pub. No.: US 2023/0344708 A1
(43) Pub. Date: Oct. 26, 2023

(54) Dynamic Spawning of CU-UP Instances and Migration of Some Active Subscribers

(71) Applicant: Parallel Wireless, Inc., Nashua, NH (US)

(72) Inventors: Mukesh Singhal, Pune (IN); Amit Ghadge, Pune (IN)

(21) Appl. No.: 18/306,234

(22) Filed: Apr. 24, 2023

Related U.S. Application Data
(60) Provisional application No. 63/333,596, filed on Apr. 22, 2022.

(51) Int. Cl. H04L 41/0816; H04L 41/08; H04W 28/16

(52) U.S. Cl. CPC H04L 41/0816; H04L 41/0886; H04W 28/16; H04W 84/042

(57) ABSTRACT

This disclosure provides dynamic spawning of CU-UP instances and migration of some of active subscribers from overloaded CU-UP instance to newly created CU-UP instance without service disruption. In one embodiment, a method of migrating an active subscriber from a first Centralized Unit-User Plane (CU-UP) instance to a newly provided second CU-UP instance includes determining a first CU-UP requires service; spawning the second CU-UP instance; and migrating a subscriber from the first CU-UP instance to the second CU-UP instance.

### CROSS-REFERENCE TO RELATED APPLICATIONS

The present application claims priority under 35 U.S.C. § 119(e) to U.S. Provisional Patent Application No. 63/333,596, having the same title as the present application and filed Apr. 22, 2022, which is hereby incorporated by reference in its entirety for all purposes. Also, the present application hereby incorporates by reference U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); and Ser. No. 15/713,584 (PWS-71850US03). This application also hereby incorporates by reference in their entirety U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019.

### BACKGROUND

The 3GPP 5G RAN architecture and known as NG-RAN, introduces new interfaces and functional modules. The NG-RAN consists of a set of radio base stations i.e. gNBs which is connected to 5GC (5G core network). The gNB has three main functional modules: the Centralized Unit (CU), the Distributed Unit (DU) and the Radio Unit (RU).

The CU is further disaggregated into CU control plane (CU-CP) and CU data plane (CU-UP). CU-CP: This node handles RRC and the control plane part of the PDCP protocol. This node communicates with DU over F1-C interface and with CU-UP over E1 interface as defined in 3GPP specifications. CU-UP: This node handles user plane part of PDCP protocol and SDAP protocol. It communicates with CU-CP over E1 interface and with DU over F1-U interface.

### SUMMARY

This invention provides dynamic spawning of CU-UP instances and migration of some of active subscriber from overloaded CU-UP instance to newly created CU-UP instance without service disruption. Same mechanism can be used to migrate subscriber from under loaded CU-UP instances to sub-set of other CU-UP instances during non-peak hours. Seamless version upgrade or maintenance of CU-UP without impacting subscriber services.

In one embodiment, a method of migrating an active subscriber from a first Centralized Unit-User Plane (CU-UP) instance to a newly provided second CU-UP instance includes determining a first CU-UP requires service; spawning the second CU-UP instance; and migrating a subscriber from the first CU-UP instance to the second CU-UP instance. The determining a first CU-UP requires service comprises determining the first CU-UP instance is one of overloaded; underloaded, requires an upgrade; or requires maintenance.

### BRIEF DESCRIPTION OF THE DRAWINGS

FIG. 1 is a schematic diagram of a 5G RAN, in accordance with the prior art.

FIG. 2 is a schematic diagram of a CU-UP showing internal architecture, in accordance with some embodiments.

FIG. 3 is a schematic diagram of a non-peak hour deployment, in accordance with some embodiments.

FIG. 4 is a schematic diagram of a peak hour deployment with CU-UP auto spawning, in accordance with some embodiments.

FIG. 5 is a schematic diagram of a high-level call flow showing CU-UP dynamic spawning, in accordance with some embodiments.

FIG. 6 is a schematic diagram of a detailed call flow showing subscriber migration during CU-UP dynamic spawning, in accordance with some embodiments.

FIG. 7 is a schematic diagram of a call flow showing CU-UP dynamic spawning during software upgrade, in accordance with some embodiments.

FIG. 8 is a schematic diagram of a microservice control architecture, in accordance with some embodiments.

### DETAILED DESCRIPTION

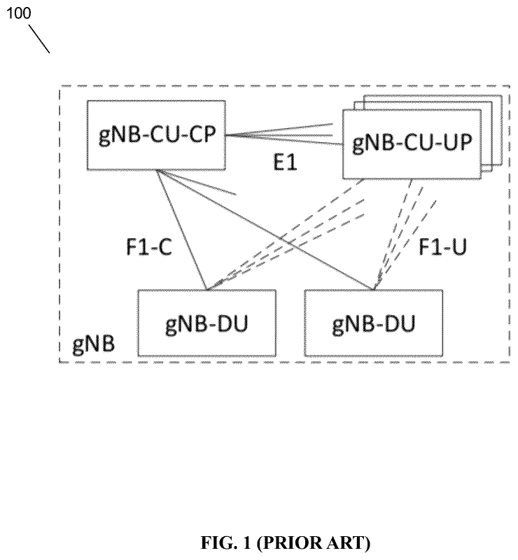

FIG. 1 is a schematic diagram of a 5G RAN, in accordance with the prior art. The figure shows an example gNB having CU, DU and RU.

A single CU-UP would cater to few DUs and few thousand subscribers. 5G technology makes it easy to provide few Gbps traffic to single subscriber. There can be possibility of non-peak and peak hour total throughput requirement can very a by large proportion. we can assume it to be 1:100 times scaling difference between peak and non-peak hour throughput requirement. To achieve this large variation of throughput requirement, we would need efficient way to deploy resources as and when needed.

A single CU-UP can handle few thousand subscriber and 100s of Gbps throughput. If traffic during peak hours crosses limit, we would need more CU-UP nodes and migration of active subscriber from loaded CU-UP to newly created CU-UP instance.

Additionally, there is the problem of seamless version upgrade of CU-UP instance.

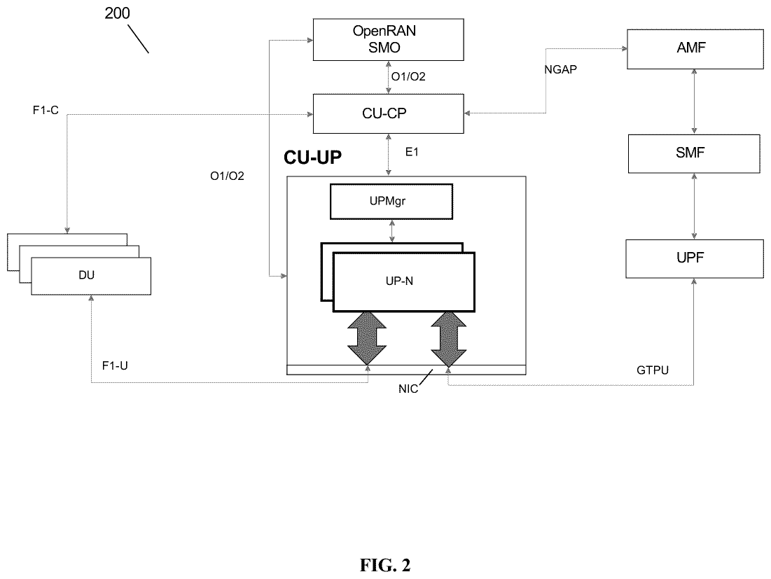

FIG. 2 is a schematic diagram of a CU-UP showing internal architecture, in accordance with some embodiments. In addition to 3GPP known nodes, the following are described.

UPMgr: UPMgr is logical entity which manages all the user plane POD instances in single CU-UP.

UP-N: User plane ‘Nth’ instance for handling CU-UP data plane traffic. Each instance is a single pod.

OpenRAN SMO: OpenRAN Service management and orchestrator layer which manages spawning of CU-UP and CU-CP instances.

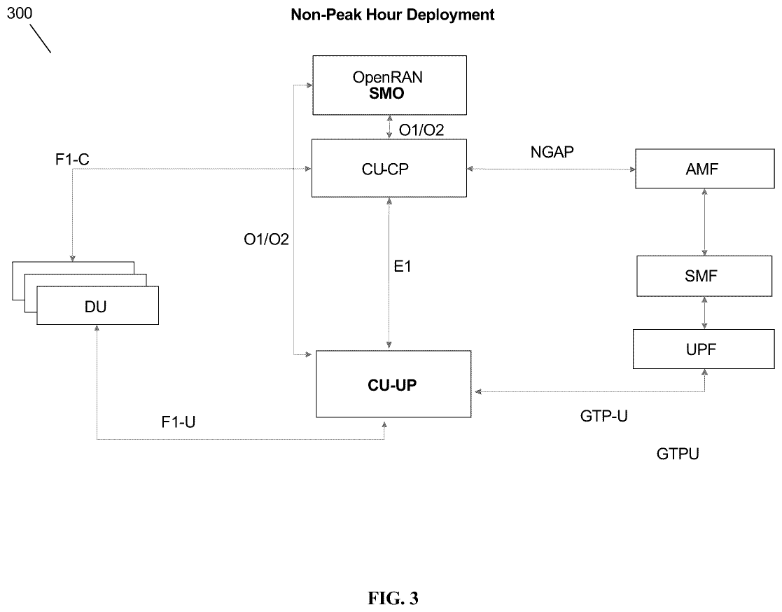

FIG. 3 is a schematic diagram of a non-peak hour deployment, in accordance with some embodiments, that is capable of dynamic spawning as described below. Without spawning, the infrastructure shown is capable of handling a certain level of performance.

TABLE 1 shows an example set of performance numbers consistent with some embodiments of the disclosure.

Assume following numbers for an example.

TABLE 1

| | | |
|---|---|---|
| Description | non-peak hour | peak hour |

| | | | | |
|---|---|---|---|---|
| Single CU-UP max throughput | 500 | Gbps | 500 | Gbps |

| | | |
|---|---|---|
| Max subscriber on CU-CP | 1M | 1M |

| | | | | |
|---|---|---|---|---|
| Avg throughput per subscriber | 1 | Mbps | 100 | Mbps |
| Total throughput required | 1 | Tbps | 100 | Tbps |

| | | |
|---|---|---|
| CU-UP Min instances required | 2 | 200 |

A scaling solution is needed that can do this add/delete CU-UP instances in a way that doesn't impact the subscribers, no impact to service and has lesser impact on the other network element. The solution proposed has following advantages: Intelligent solution taking care of all aspects of CU-UP functioning; Without impacting the subscriber and service; Has minimal impact on other functions in the network; Reduces CU-UP complexity; Dynamic solution that considers the network needs and it doesn't need any manual intervention; Makes efficient utilization of resources; Increases power consumption efficiency; and Reduces cost.

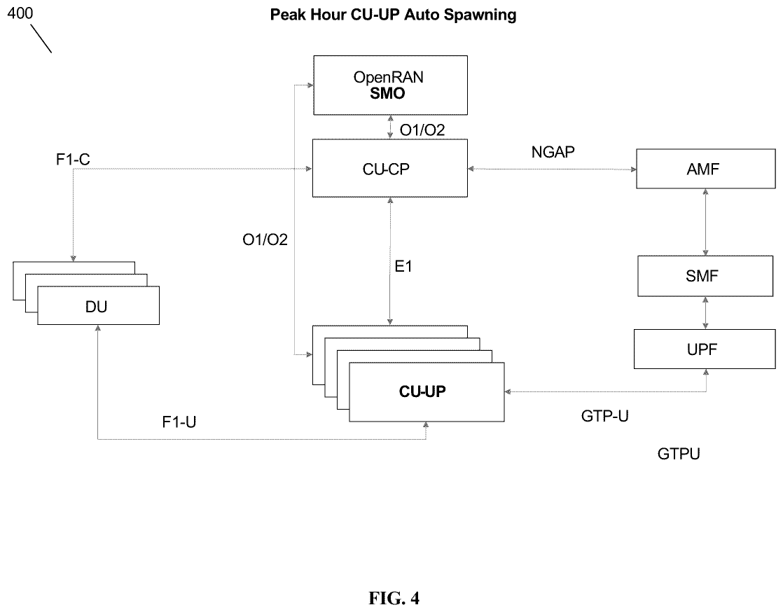

FIG. 4 is a schematic diagram of a peak hour deployment with CU-UP auto spawning, in accordance with some embodiments.

CU-UP node can be deployed as an edge cloud CNF (cloud-native network function). With CNF infrastructure, Network operator can utilize flexibility offered by CNF infra, OpenRAN & 3GPP specification and apply it in CU-UP scaling as needed. An Intelligent & Dynamic solution is needed to support dynamic spawning for CU-UPs and migration of subscribers from overloaded CU-UPs. Proposed solution has CU-UP to be implemented as a CNF.

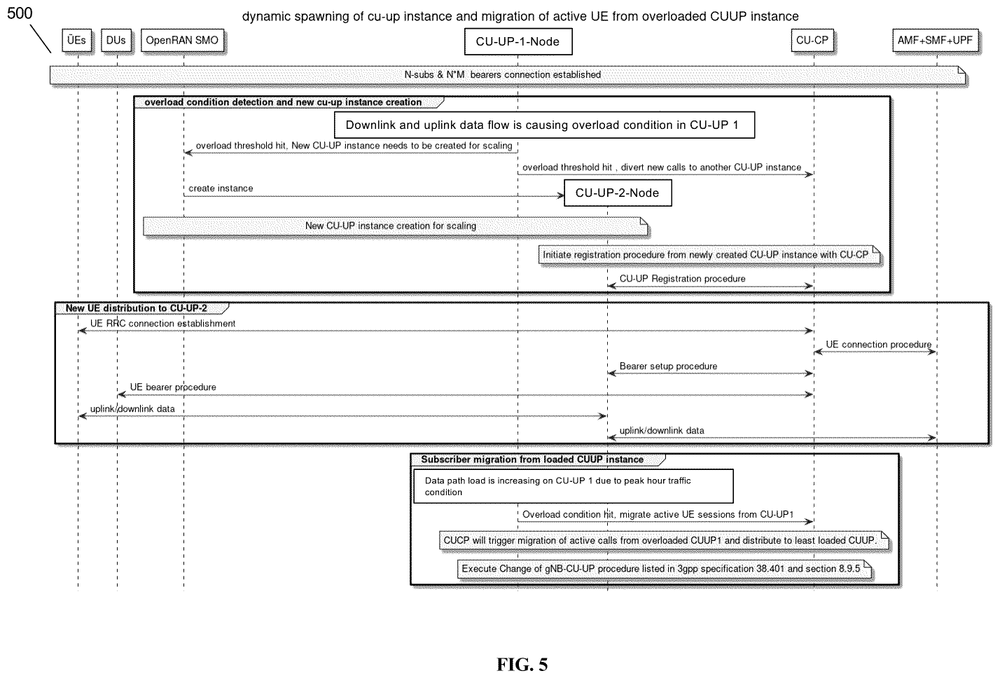

FIG. 5 is a schematic diagram of a high-level call flow showing CU-UP dynamic spawning, in accordance with some embodiments. Intelligent spawning of CU-UP instance and subscriber migration from overloaded CU-UP is shown.

Above call flow divided into 3 parts: Detection of overload condition & creation of new CU-UP instance; New subscriber distribution to least loaded/newly created CU-UP instance; and Migration of active subscriber from overloaded CU-UP to least loaded CU-UP instance without loss of service to UE.

In part 1, CU-UP informs OpenRAN SMO & CU-CP for overload conditions & possible action to mitigate overload conditions at CU-UP. Based on input provided by CU-UP, SMO initiates spawning of new CU-UP instances.

New CU-UP instances will initiate registration procedure with CU-CP and provide max throughput and subscriber capacity that can be handled by CU-UP instance.

Based on overload condition provided by CU-UP, CU-CP can start migration of active subscriber to least loaded CU-UPs or based on configured policy at CU-CP.

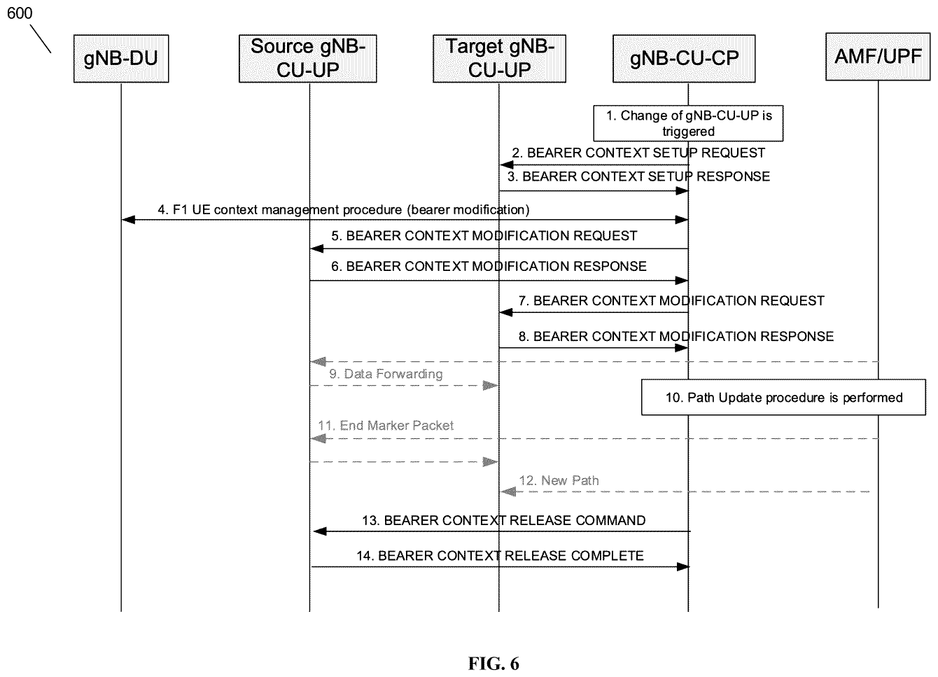

FIG. 6 is a schematic diagram of a detailed call flow showing subscriber migration during CU-UP dynamic spawning, in accordance with some embodiments. Subscriber migration from overloaded gNB-CU-UP is shown.

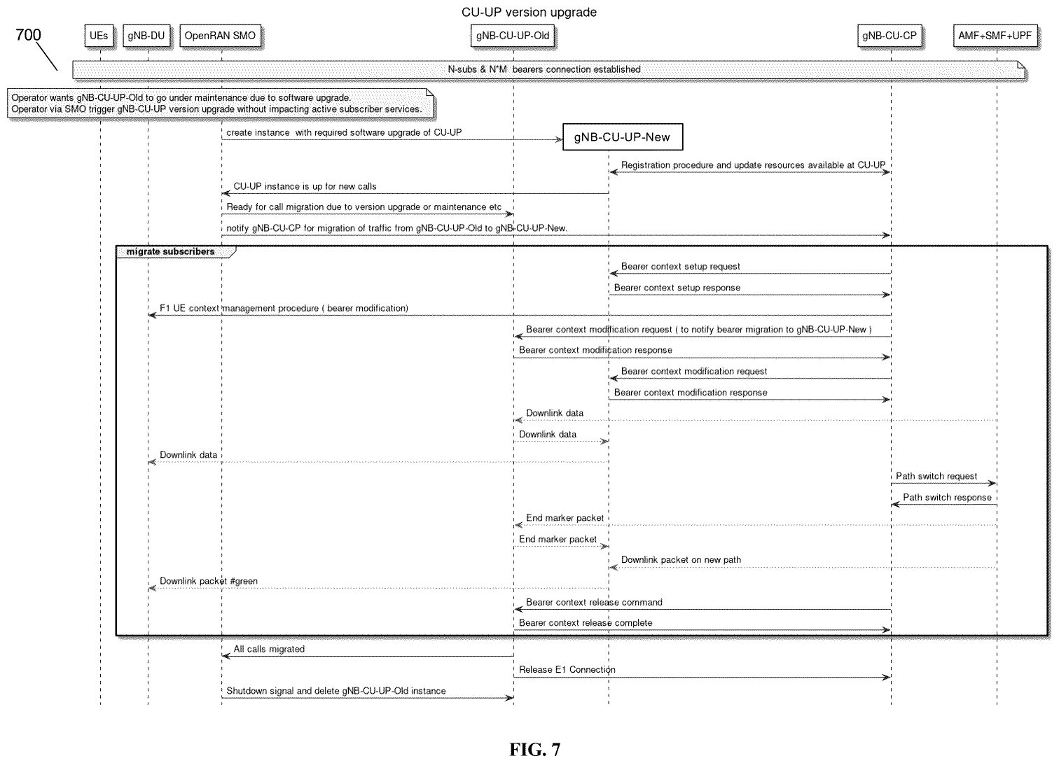

FIG. 7 is a schematic diagram of a call flow showing CU-UP dynamic spawning during software upgrade, in accordance with some embodiments. CU-UP seamless version upgrade or maintenance support is enabled.

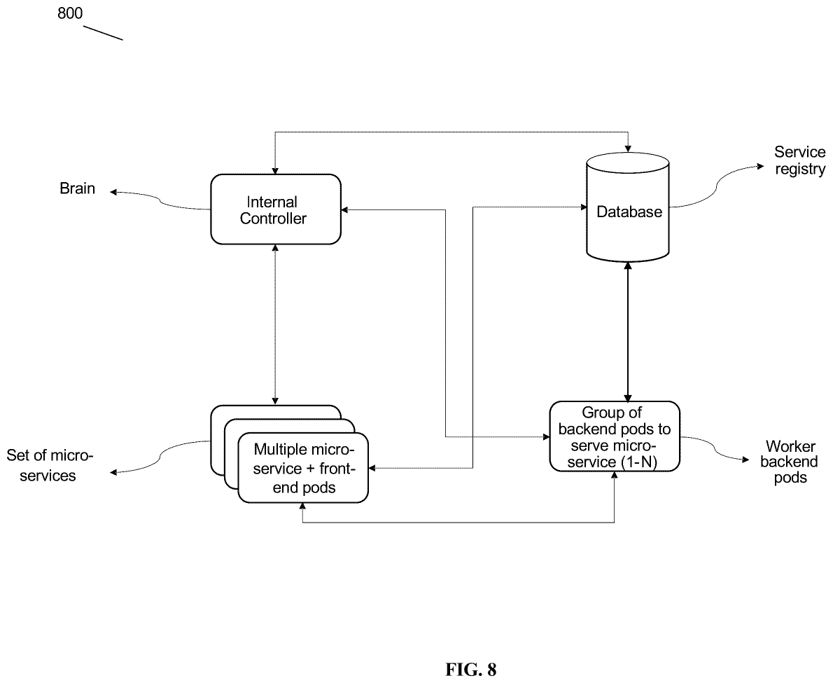

FIG. 8 is a schematic diagram of a microservice control architecture, in accordance with some embodiments. Shown is a schematic diagram showing a pod microservice logical architecture with front and back-end pods, in accordance with some embodiments. A plurality of front-end pods for terminating connections and back-end pods for handling and processing traffic is in communication with a database; the database handles registration of the pods as described below. Other nodes, such as peer nodes, interface with the microservice via a particular service IP, and routing is performed within the microservice to the front end pods and back end pods, in some embodiments by a routing pod.

In some embodiments, an internal controller keeps track of health of some or all pods & micro services in a given namespace. As soon as any pod/container crashes, it updates the remaining pods. And takes necessary steps to bring system in workable state.

In some embodiments, a database (Service registry) may act as service registry database for some or all pods and microservice in given namespace. All the pods on start-up can update required information in database & fetch required information from service registry database.

The disclosed high availability solution is intended to enhance availability of a single pod solution, as follows. In Kubernetes, a Pod (as in a pod of whales or pea pod) is a group of one or more containers, with shared storage and network resources, and a specification for how to run the containers. A Pod's contents may be co-located and co-scheduled, and run in a shared context. A Pod models an application-specific “logical host”: it contains one or more application containers which are relatively tightly coupled. In non-cloud contexts, applications executed on the same physical or virtual machine are analogous to cloud applications executed on the same logical host. Pods get their own IP and services get a cluster IP. Cluster IP is internal only. Kubernetes creates a cluster when a pod is created. Kubernetes supports a method for tracking which pods are available and/or down. It tracks which ones are live and which ones are down. While Kubernetes is described herein, other container management and orchestration methods are understood to be supported in the spirit of the present disclosure.

Pods are configured in Kubernetes using YAML files. A controller for the resource handles replication and rollout and automatic healing in case of Pod failure. For example, if a Node fails, a controller notices that Pods on that Node have stopped working and creates a replacement Pod. The scheduler places the replacement Pod onto a healthy Node.

In telecom, it is desirable to have a single controller running at a single time, not multiple controllers. This is because there are often situations where state is required to be kept at the service provider. This results in a single controller being visible, and, standby controller being invisible to others. However, Kubernetes does not have any concept of active and standby, and this concept is facilitated by the addition of labels or selectors as follows.

In some embodiments, an all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interworking processes or which may involve supporting a subset of available commands for a RAT, in some embodiments.

Automatic and dynamic are used interchangeably in some portions of this disclosure. In some embodiments, scaling by adding additional instances is understood to be horizontal scaling, as more machines or instances are being added instead of adding additional resources (CPU, RAM, networking etc) to an existing instance or machine.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method of migrating an active subscriber from a first Centralized Unit-User Plane (CU-UP) instance to a newly provided second CU-UP instance, the method comprising:
determining that a first CU-UP requires service;
spawning a second CU-UP instance; and
migrating a subscriber from the first CU-UP instance to the second CU-UP instance.

2. The method of claim 1, wherein determining a first CU-UP requires service comprises determining the first CU-UP instance is one of overloaded, underloaded, requires upgrade, or requires maintenance.
